(19) United States
(12) Patent Application Publication
(10) Pub. No.: US 2025/0259325 A1
(43) Pub. Date: Aug. 14, 2025

(54) ARTIFICIAL INTELLIGENCE AND VISION-BASED BROILER BODY WEIGHT MEASUREMENT SYSTEM AND PROCESS

(71) Applicant: BOARD OF TRUSTEES OF THE UNIVERSITY OF ARKANSAS, Little Rock, AR (US)

(72) Inventors: Michael T. Kidd, Springdale, AR (US); Thi Hoang Ngan Le, Fayetteville, AR (US); Khoa Ho Viet Vo, Fayetteville, AR (US)

(73) Assignee: BOARD OF TRUSTEES OF THE UNIVERSITY OF ARKANSAS, Little Rock, AR (US)

(21) Appl. No.: 18/685,805

(22) PCT Filed: Aug. 30, 2022
(86) PCT No.: PCT/US2022/075709

§ 371 Date: Feb. 22, 2024

Related U.S. Application Data
(60) Provisional application No. 63/238,625, filed on Aug. 30, 2021.

(51) Int. Cl. G06T 7/62; G06T 7/10; G06T 7/20; G06T 7/70; G06T 7/80; G06T 17/00; G06V 10/54; G06V 20/70

(52) U.S. Cl. CPC G06T 7/62; G06T 7/10; G06T 7/20; G06T 7/70; G06T 7/80; G06T 17/00; G06V 10/54; G06V 20/70; G06V 2201/07

(57) ABSTRACT

This invention generally relates to a system and process for determining the weight of a plurality of chickens within a containment area over time. A three-dimensional model of each chicken is constructed from image or video data acquired from cameras trained on the plurality of chickens. The volume of each of the three-dimensional models is electronically determined and correlated with an estimated weight for the chicken.

### CROSS-REFERENCE TO RELATED APPLICATIONS

This application claims the benefit of U.S. Provisional Patent Application No. 63/238,625 filed on Aug. 30, 2021, and incorporates said provisional application by reference in its entirety into this document as if fully set out at this point.

### BACKGROUND OF THE INVENTION

### 1. Field of the Invention

This invention generally relates to a system and process for determining broiler weight measurements using artificial intelligence-enhanced camera systems.

### 2. Description of the Related Art

Chicken meat is one of the most popular protein sources in the human diet, and its consumption has been increasing due to its low price and availability over the past decades. The surge in consumption is directly correlated with the rising poultry production. Nonetheless, more efforts from the industry and the academic community are needed to maintain this growth rate in production to meet the public demand while maintaining the meat quality. Increased consumption of poultry products will be a certainty for global food security achievement in the upcoming years based on the efficiency of the utilization of poultry, as well as a diverse consumer acceptance. The Food and Agriculture Organization of the United Nations 2005/2007 has projected that production of poultry will increase more than 100 percent by the year 2050 with an increased tonnage of poultry products, primarily broiler chickens, surpassing 180 million tons, with the current projection estimated at just over 80 million tons. In the U.S., broiler chicken efficiency of feed utilization has increased seven percent from 2010 to the present at a similar slaughter age between 47 and 48 days across the decade.

The poultry industry continues to implement improved housing technologies to optimize flock health, well-being, growth, and efficiency. A safe broiler product, coupled with heightened management of pre-harvest bird welfare and environmentally friendly production, is necessary, regardless of the region where broilers are grown. Indeed, precision nutrition and housing management systems have realized U.S. broiler chicken efficiency from an advanced breeding selection at the pedigree level. Feeding programs such as “antibiotic-free” and “reduced protein” have also been adopted to complement optimized housing technologies. Although beneficial in many ways, these new technologies can result in flocks not performing to their genetic potential/efficiency.

To allow the birds to grow in an undisturbed environment, a broiler body weighting system should not disturb the bird. Broiler body weight predictions can assess flock growth for health, well-being, feed delivery needs, and day of slaughter. Visual Animal Biometrics (VAB) technology, which was created by combining visual and pattern recognition with digital photography, has proven beneficial in animal science. However, accurate broiler body weight technology is needed and is more challenging than other food animals due to the rapid growth rate and relatively short production cycle of commercial broilers. Furthermore, broiler body weight needs to be monitored in real-time to detect any efficiency reduction early.

In the past, industry participants have used suspended “hop-on, hop-off” scales in commercial broiler houses to predict the growth rate of the flock. Although widely accepted, “hop-on, hop-off” scales suffer several deficiencies. First, as birds become compromised, they tend to move less, which limits interaction with the scale. Second, as birds increase in body weight, they tend to visit the scales less. Third, the scales only provide a growth curve for a small percentage of active-healthy birds. These deficiencies frustrate efforts to comprehensively understand the percentage of the flock that is compromised unless mathematical equations are used to extrapolate reduced feed or water intake. These extrapolations are subject to significant error and cannot provide direct, “real-time” assessments of the flock's health.

### SUMMARY OF THE INVENTION

This invention relates to a system and process for determining broiler body weight using computer-automated analysis of vision-based data. The system and process include constructing a three-dimensional model of each chicken from image data acquired from cameras trained on the plurality of chickens. The system and process also determine an estimated volume for each three-dimensional model. The system and process further correlate the estimated volume of the three-dimensional model with an estimated weight for the corresponding chicken.

Accordingly, it is an object of this invention to provide a new and improved system and process for determining flock health as a function of broiler weight, which overcomes the deficiencies of traditional scale-based weighing systems.

Another object of this invention is to provide artificial intelligence and vision-based broiler body weight measurement systems and processes that allow for real-time estimation of body weight measurements of all birds in a flock.

Another object of this invention is to provide artificial intelligence and vision-based broiler body weight measurement systems and processes that allow flock variation as a function of compromised fitness, health, well-being, and nutrition to be corrected immediately, such as by providing remote, real-time flock percentage issues so that corrective management, water supplementation, diet alterations, or veterinary care can be administered.

A further object of this invention is to provide artificial intelligence and vision-based broiler body weight measurement systems and processes that allow a user to monitor and/or predict environmental diet administration and to administer a test recovery diet feeding, which in turn results in predictable broiler body weight with less nitrogen and water inputs.

### BRIEF DESCRIPTION OF THE DRAWINGS

The above and other objects and advantages of this invention may be more clearly seen when viewed in conjunction with the accompanying drawing wherein:

FIG. 1 depicts an example of an artificial intelligence and vision-based broiler body weight measurement system constructed in accordance with illustrative embodiment of the invention disclosed herein.

FIG. 2 is a flow diagram for an example of a process for determining broiler weight using an artificial intelligence analysis of vision-based data obtained from one or more broiler chickens in accordance with illustrative embodiment of the invention disclosed herein.

FIG. 3 is a stepwise visualization of the process shown in FIG. 2.

FIG. 4 depicts a landmarking scheme for annotating images of each broiler chicken in accordance with illustrative embodiment of the invention disclosed herein.

FIG. 5 depicts examples of camera strategies for acquiring sufficient image data about each broiler chicken in accordance with illustrative embodiment of the invention disclosed herein.

FIG. 6 depicts a stepwise visualization of an example of an artificial intelligence and vision-based broiler body weight measurement system constructed in accordance with illustrative embodiment of the invention disclosed herein.

FIG. 7 depicts a stepwise visualization of a data preprocessing module step shown in FIG. 6.

FIG. 8 depicts an example of an architecture of a network predictor module step shown in FIG. 6.

FIG. 9 depicts an example of a rest shape reconstruction using a mesh constructor module step shown in FIG. 6.

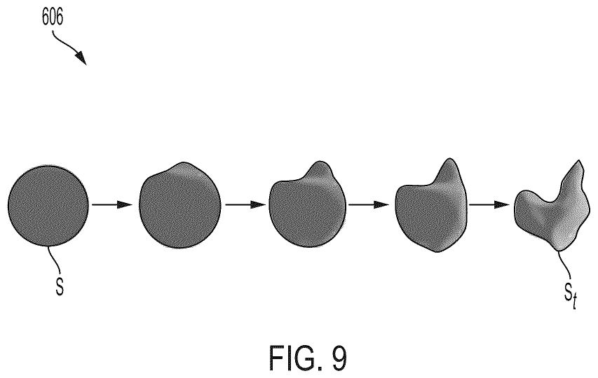

FIG. 10 depicts an example of a 3D reconstruction result from a differential renderer module step and/or a reconstruction loss module step shown in FIG. 6.

### DETAILED DESCRIPTION OF THE INVENTION

While this invention is susceptible to embodiment in many different forms, there are shown in the drawings and will herein be described hereinafter in detail some specific embodiments of the invention. It should be understood, however, that the present disclosure is to be considered an exemplification of the principles of the invention and is not intended to limit the invention to the specific embodiments so described.

The terms “broiler,” “bird,” and “chicken” may be used interchangeably unless distinctions are specifically referenced in this disclosure.

It has been determined that there is a strong relationship between a broiler chicken's volume and its body weight. Rather than obtaining broiler weights with conventional “hop-on, hop-off” scales, which can be unreliable for the above reasons, inventive systems and methods provided herein determine the weight of single and multiple broilers using camera-derived images, which are processed and analyzed using computer-based artificial intelligence. The artificial intelligence and vision-based broiler body weight measurement system and process permit the real-time determination of body weight measurements for all the birds in a flock through a non-intrusive, harmless data acquisition system and process that overcomes the deficiencies of the prior art. The improved body weight measurements also permit the accelerated identification of variation within the flock, which may be an expression of compromised fitness, health, well-being, and nutrition. By providing a more comprehensive weight measurement system that covers the entire flock, including infirm and compromised birds, appropriate remedial measures can be quickly taken. Moreover, computer vision and artificial intelligence-derived final body weight measurements can provide expected yields and parts weights for food sales contracts before the birds are slaughtered.

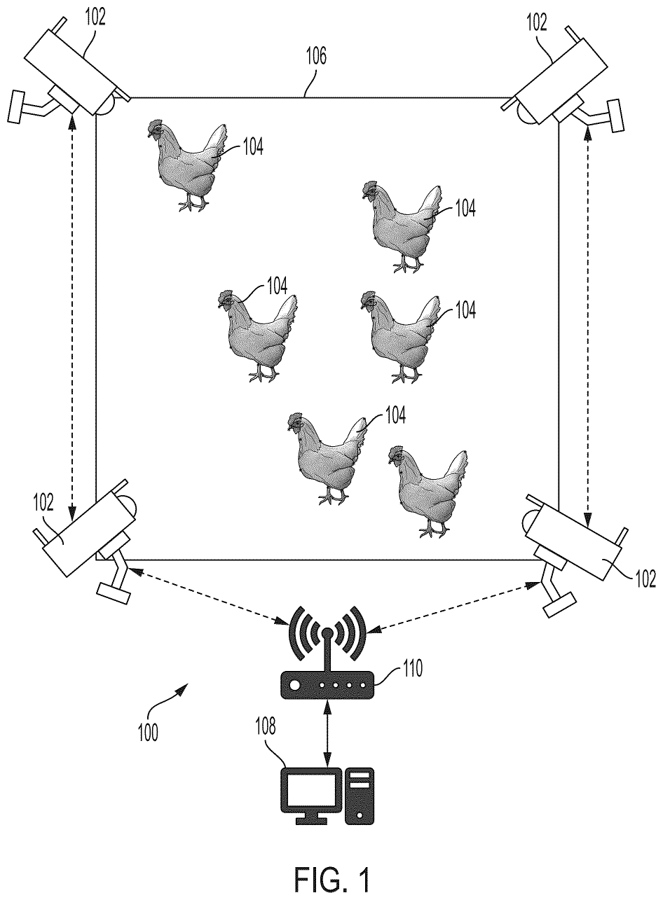

Referring to the drawings in detail, FIG. 1 illustrates a system 100 for broiler weight determinations that generally includes one or more cameras 102, which are configured to obtain digital images, still frames, and/or video images of one or more broiler chickens 104 within a rearing pen or containment area 106. If the system 100 is utilized with video images of broiler chickens 104, video frames can be extracted and processed as provided herein. Preferably, the images are high-definition digital images (e.g., 24 MB digital images), but other arrangements are possible (e.g., 4 k or higher video images). The cameras 102 can be configured to record and output color and depth (i.e., RGB-D) images in digital formats. The images are directed to a computer system 108 through a data network 110. It will be appreciated that the computer system 108 may include a single computer or a plurality of interconnected computers that reside in local and remote locations. It will be further appreciated that the post-acquisition analysis of image data obtained from the cameras 102 will be carried out with computer-implemented instructions stored and executed within the computer system 108.

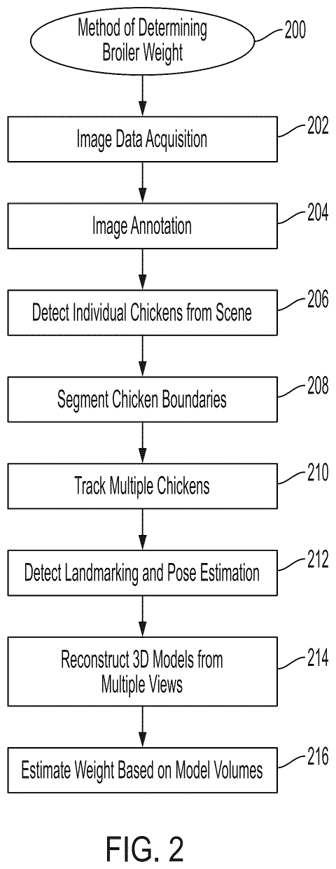

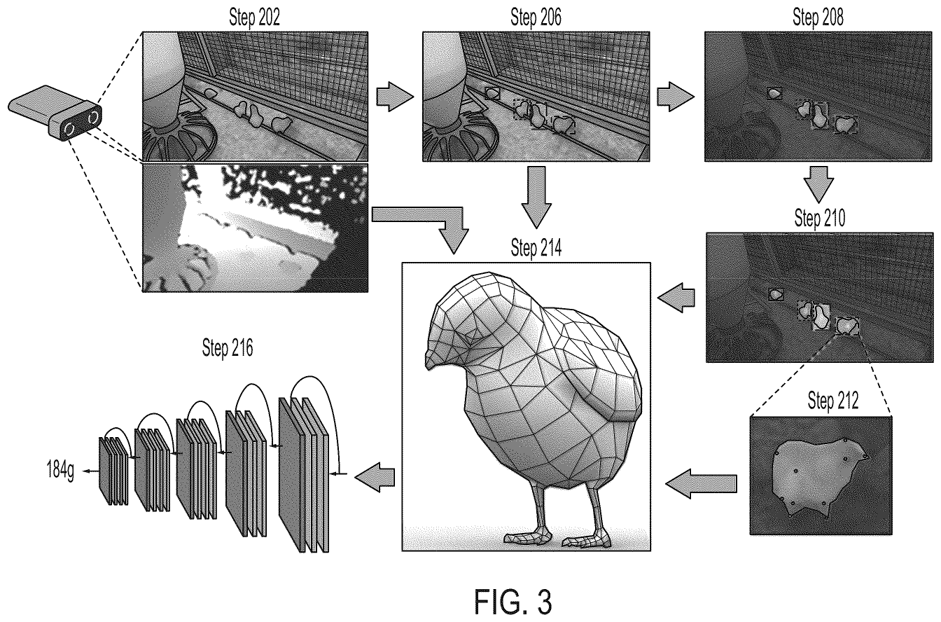

FIG. 2 is a flow diagram for a process 200 of determining broiler weights through artificial intelligence-enhanced processing of image data taken by one or more cameras 102. Generally, the process 200 involves using the computer system 108 to reconstruct the volume of the broiler chicken 104 from images obtained from the cameras 102. Several of the steps included within the process 200 are graphically depicted in FIG. 3.

As illustrated in FIG. 2, the process 200 begins at step 202, in which images (or video) of one or more broiler chickens 104 are acquired by the cameras 102. To achieve a robust system capable of reconstructing the geometry of every chicken 104 individually and, in turn, estimating their corresponding volume and weight, the broiler weight determination system 100 is configured to record data over a span of time, from the date the broiler chickens 104 are first introduced to the containment area 106 to the date the broiler chicken 104 are removed for processing. The image data acquisition that occurs at step 202 can be configured to provide data and measurements for multiple downstream steps within the process 200.

In a first bulk acquisition mode of operation, the broiler weight determination system 100 is configured to acquire data from multiple chickens 104 in a given containment area 106, as depicted in FIG. 1. In this mode of operation, the images obtained by the broiler weight determination system 100 are used as training data for steps 204 through 212 of the process 200. In a second verification mode of operation, the broiler weight determination system 100 is configured to monitor an isolated bird 104 in the containment area 106. The images obtained of the isolated bird 104 are matched with an actual weight obtained for the isolated bird 104 on a periodic (e.g., once/day) basis. This verification mode of operation is primarily used to acquire testing data for the evaluation of the bulk acquisition mode of operation described in steps 204 through 212. Additionally, the recorded weights of chickens 104 in each pen 106 will be utilized to train a regression module to map the chicken geometry to corresponding weights.

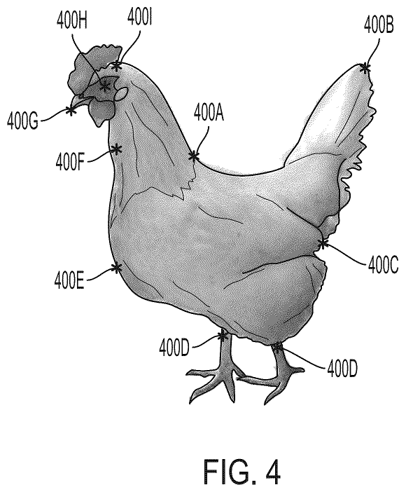

Turning to step 204, which is available during training, the images of the broiler chickens 104 obtained at step 202 are annotated automatically by the broiler weight determination system 100 with training, manually by an operator, or through a combination of manual and automated processes. The chicken landmarking points detection module described in step 204 makes use of all the RGB frames recorded by the cameras 102. In every frame, landmarking points 400 of each chicken 104 are annotated. As illustrated in FIG. 4, an exemplary landmarking scheme includes landmark points 400 placed on the back 400A, tail 400B, rear 400C, legs 400D, breast 400E, neck 400F, beak 400G, eyes 400H, head 400I, or a combination thereof of the chicken 104. The landmarking process can be done automatically by the broiler weight determination system 100 with training, manually by an operator, or through a combination of manual and automated processes.

At step 206, the broiler weight determination system 100 detects individual birds 104 from the image scenes recorded by the cameras 102. Training data for the chicken detection and segmentation module described in step 206 can be a set of all RGB frames captured by the cameras 102. As illustrated in FIG. 3, a tight bounding box with a segmentation mask around every chicken 104 can be annotated in every frame. The depth frames are essential to the accuracy of the chicken three-dimensional (“3D”) geometry reconstruction. Depth frames also help in releasing the constraints in 3D reconstruction compared with 3D construction based solely on RGB frames.

At step 208, the boundary of each chicken 104 is detected and segmented. The machine learning (e.g., deep neural network) for detection and segmentation in step 208 is trained on the specialized chicken dataset collected and annotated in steps 202 through 204. In some cases, step 208 of detecting and segmenting the chickens 104 can be frustrated by occlusion and weak boundaries between adjacent chickens. To overcome these challenges, the broiler weight determination system 100 employs state-of-the-art computer-implemented methods based on level set-based weak boundary segmentation network and shape constrained network.

Once the broiler weight determination system 100 has detected and segmented each chicken 104, the process 200 moves to step 210 when multiple chickens 104 are simultaneously tracked. To connect multiple frames captured from each pen, the broiler weight determination system 100 applies a multiple object tracking (MOT) network. Typically, MOT networks work well to track humans and cars because of the distinct appearance of each human, the predictable flow-like movement, and the non-rigid shape of each car. Chickens, however, do not have these characteristics because they all share the same appearance, and movements within the containment area 106 are unpredictable. To resolve this problem, the broiler weight determination system 100 not only trains the MOT network on the collected data, which is specifically targeted at tracking chickens but also incorporates a segmentation network with shapes to deal with occlusion, especially when multiple chickens are crossing one another within the frame. To prevent losing track of individual chickens 104 when multiple chickens 104 are crossing one another in the frame, cameras will be configured at a top-down angle in addition to side-targeted cameras. Every chicken 104 in the containment area 106 is identified by a unique identifier (“ID”), which is tracked throughout the recording time period.

Once each chicken 104 has been identified by the broiler weight determination system 100, the process 200 moves to step 212, where the broiler weight determination system 100 determines the landmarking and pose of each chicken 104. In an exemplary embodiment, the broiler weight determination system 100 employs a cascaded convolutional neural network (C-CNN) paired with a regression network for simultaneously detecting landmarks and estimating the chicken pose. The cascaded convolutional neural network can consist of a regression subnetwork and cascaded heatmaps of multiple successive heatmap-based localization subnetworks. The neural network for determining chicken landmarking points and pose estimation is also trained on the specialized chicken dataset collected and annotated in steps 202 and 204.

Next, at step 214, the broiler weight determination system 100 constructs 3D models of each chicken 104 from multiple views taken and annotated in steps 202 and 204. To apply 3D reconstruction on moving chickens 104, the broiler weight determination system 100 may follow non-rigid 3D reconstruction paradigms, which do not require the observation scene to be still or constraint the camera movements. The broiler weight determination system 100 may incorporate, for example, a multiple-views strategy to obtain a sufficient quantity of visual information around each chicken 104.

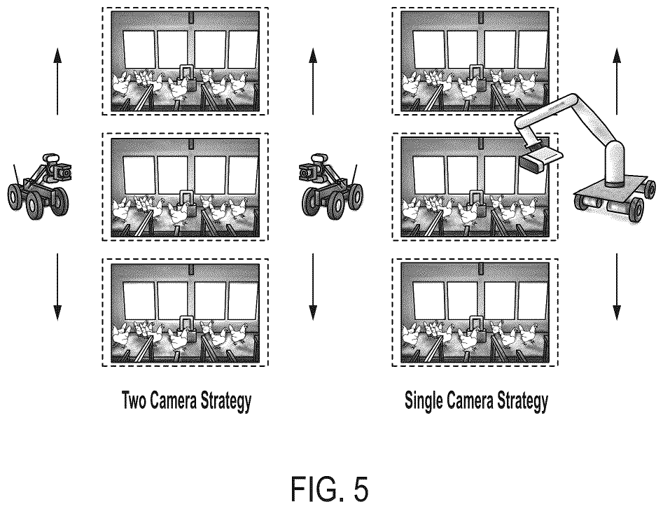

Multiple views of the chicken 104 can be collected from multiple cameras 102 viewing at different positions around each containment area 106, or from a single camera 102 continuously moving to different positions around each containment area 106. FIG. 5, for example, provides two examples for deploying both multiple camera and single camera strategies. For multiple camera strategies, the broiler weight determination system 100 can include two mobile cameras 102 cameras that track along opposite sides of the containment area 106 to efficiently capture a complete, 360-degree view of the containment area 106. For a single camera strategy, the broiler weight determination system 100 can include a single camera 102, which is attached to a long arm robot, which moves from side to side across the containment area 106 to form a continuously dynamic view of the entire containment area 106.

For each chicken 104, the broiler weight determination system 100 collects its segmentation masks, landmarking points, and poses in every collected frame at multiple views using the neural networks described in steps set forth above. The broiler weight determination system 100 then can employ advanced approaches to reconstructing 3D models of each chicken 104 using isolated visual information of each chicken and accurate chicken pose determinations, which are consistently identified across multiple image frames. Alternatively, the broiler weight determination system 100 can employ a model-free 3D reconstruction method that adopts a deep learning model to address the under-constrained nature between 2D images and 3D shapes, which aids in stabilizing the shape recovery and enhancing the process of pose retrieval from 2D images.

Following the construction of accurate 3D models for each chicken 104, the broiler weight determination system 100 determines the weight of each chicken 104 based on its estimated volume, which is calculated from the 3D model. The correlation between chicken volume and weight can be determined using a regression neural network that is trained on the daily recorded weights and RGB-D frames obtained at step 202. The regression network used to determine chicken weight may be based on the geometry of each chicken 104 to estimate various latent parameters, which can then be used to predict the final body weight of the chicken.

Based on the reconstructed 3D model geometry and weight estimates determined over a period of time, the broiler weight determination system 100 can be configured to predict the future growth development of the chicken 104. Additionally, the broiler weight determination system 100 can be optimized for energy-efficient training and inference to process the data obtained from the cameras 102 at large scale on portable devices and cameras.

The broiler weight determination system 100 can be used to aid broiler production for optimal welfare and sustainability adjustments. Using the predictive functions of the broiler weight determination system 100, commercial operators can make early-stage adjustments to diet and feed schedules before adverse effects are realized in the flock. The broiler weight determination system 100 can be used to adjust diet administration to provide good predictable broiler body weight with less nitrogen and water inputs. The broiler weight determination system 100 can also be used to provide remote, real-time flock monitoring to identify and remediate morbidity issues with corrective management, water supplementation, diet alterations, or veterinary care.

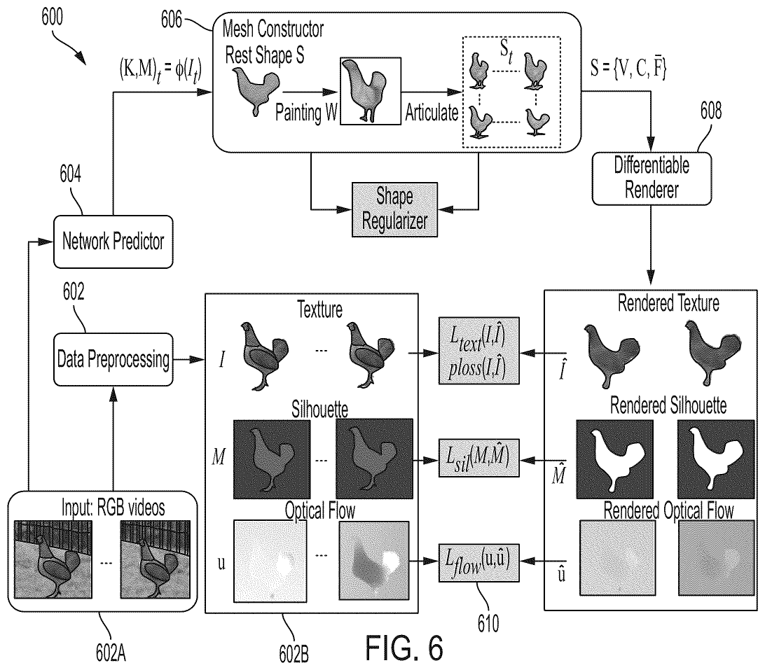

The broiler weight determination system 100 is further illustrated by the following example directed to a real-time computer vision system for 3D chicken volume reconstruction from a monocular RGB video with multiple views, which are provided for the purpose of demonstration rather than limitation. The exemplary system 100 is designed with self-supervised learning requiring no training data, and directly recovers the pose of the chicken from a single image without a model fitting stage. FIG. 6 is an architectural diagram illustrating a process 600 of determining broiler weights through artificial intelligence-enhanced processing of an RGB video taken by one or more cameras 102. In the following example, the process 600 for 3D chicken volume reconstruction is configured with four (4) module steps: data preprocessing 602, network predictor 604, mesh constructor 606, and differentiable renderer 608.

The data preprocessing module step 602 applies pre-trained computer models to electronically extract the original foreground texture I, silhouette M, and optical flow u (step 602B) from an RGB video comprising a set of N consecutive frames or images 602A, i.e., V={Vₜ}^{N}ₜ₌₁. The foreground texture Iₜ of each frame 602A is computed by the system 100 by multiplying the silhouette Mₜ and the original frame/image Vₜ.

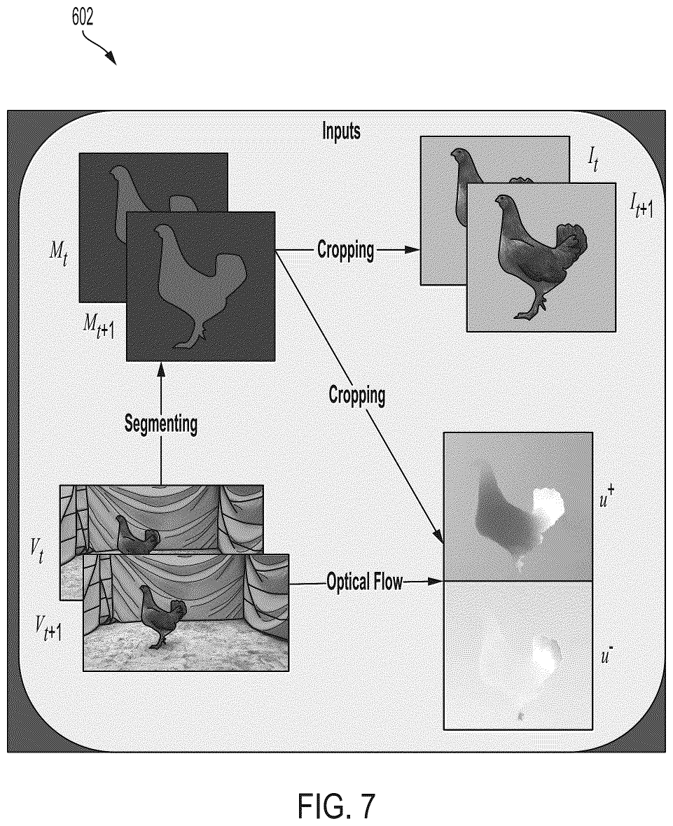

FIG. 7 shows an example of the data preprocessing module step 602, which includes three main sub-steps, namely segmenting, cropping, and extracting optical flow. With the video/frames/images 602A as input, each of the images 602A is fragmented into RGB frames and grouped into a pair, denoted as Vₜ and Vₜ₊₁. To improve shape recovery, the frames 602A are cropped to the region of interest that includes chicken only. Given that the camera's position was fixed and the objects move within the field of view, static cropping cannot be implemented, and knowledge of the object's position in each frame is required. A detection and segmentation algorithm (e.g., Detectron2) is applied on Vₜ and Vₜ₊₁, which returns the corresponding binary masks Mt and Mₜ₊₁ where entry is valid or “1” if the object covers the pixel and null or “0” otherwise. An image segmentation algorithm (e.g., Segmenter App from Matlab R2022a) can be used to further refine the masks to avoid possible interference illumination from the background. The binary masks provide the spatial information for the cropping of RGB frames, of which the data preprocessing module step 602 trims and resizes to 256 by 256 pixels Iₜ and Iₜ₊₁. Optical flow is obtained between Vₜ and Vₜ₊₁. The flow order is Vₜ to Vₜ₊₁ for the forward flow ûₜ⁺ and reversed for the backward flow ûₜ⁻. Corresponding binary masks are applied on u⁺ and ū to crop them down to the same region of interest as Iₜ and Iₜ₊₁.

TABLE 1
Summary of the chicken video dataset

| Object | Color | Duration |
|---|---|---|
| Toy chicken #1 | Mostly White | 30 seconds |
| Toy chicken #2 | Mostly Brown | 30 seconds |
| Toy chicken #3 | Mostly Dark Blue | 30 seconds |
| Real chicken #1 | Mostly Brown | 12 minutes 28 seconds |
| Real chicken #2 | Mostly Black | 10 minutes 41 seconds |
| Real chicken #3 | Black | 4 minutes 33 seconds |
| Real chicken #4 | Mostly Light Brown | 12 minutes 34 seconds |
| Real chicken #5 | White, Light Brown | 12 minutes 27 seconds |

From the data preprocessing module step 602, the network predictor module step 604 processes each texture frame/image Vₜ using a deep learning neural network process to predict a chicken pose Mₜ and camera intrinsics Kₜ. An example of the system architecture of the network predictor module step 604 is exemplified in FIG. 2, and as shown, where the network predictor module step 604 is divided into three subcomponents: a pre-trained ResNet-18 convolutional neural network 604A, a chicken pose predictor 604B, and a camera intrinsic predictor 604C. The pre-trained ResNet-18 604A takes the original frame/images Vₜ of size 256 by 256 pixels as input. The ResNet-18 604A is a stack of eighteen convolutional layers that extract spatial information from the input images Vₜ. The final layer of the ResNet-18 604A is a fully connected layer that contains the essential feature information for the pose predictor subcomponent 604B and the camera intrinsics predictor subcomponent 604C. The architecture for the pose predictor subcomponent 604B and the camera intrinsics predictor subcomponent 604C is a fully connected neural network whose input is the feature vector of size 200. The parameters that are estimated from this network predictor are formulated as follows:

$$( {K}_{t} , {M}_{t} ) = ϕ ( {V}_{t} ) \qquad ( Equation 1 )$$

where Mₜ={M_{0, t . . . ,} M_{B,t}}. The camera intrinsic parameters are not given but can be predicted from the pose predictor subcomponent 604B and the camera intrinsics predictor subcomponent 604C. The two parameters from the camera intrinsics predictor subcomponent 604C are the focal length (fₓ, f_{y}) and the principal point offset (oₓ, o_{y}). With the pose parameters Mₜ and the camera intrinsics Kₜ, the perspective projection matrix at frame t can be computed as:

$$\text{?} \qquad ( Equation 2 )$$

$$\text{?} \text{indicates text missing or illegible when filed}$$

The weights in the pose predictor 604B and the camera intrinsics predictor 604C are overfitted on this illustrative dataset; however, the weighted formula might not be used or needed for other data sets.

From the network predictor module step 604, the chicken pose {M}^{N}ₜ₌₁ from

the pose predictor subcomponent 604B and the camera intrinsics {K}^{N}ₜ₌₁ of N frames from the camera intrinsics predictor subcomponent 604C are both input to the mesh constructor module step 606 to compute the rest shape S (i.e., canonical shape) and articulated shape Sₜ for each frame Vₜ. The rest shape S can be represented by a triangular mesh with three parameters {V, C, F̅} where V∈R^{N×3} contains the position of the vertices in the 3D object's coordinate, texture C∈R^{N×3} contains the RGB color of every vertex. A fixed topology F̅ contains the set of indices corresponding to V that make triangular faces. During the optimization scheme, F̅ and texture C are shared with those of Sₜ|^{T}ₜ₌₀, but the former is fixed while the latter is updated. The vertices of the articulated shape Sₜ is denoted as Vₜ with subscript t instead of V as in rest shape S. The parameters of articulated shape Sₜ at frame t is the set of parameters including {Vₜ, C, F̅}.

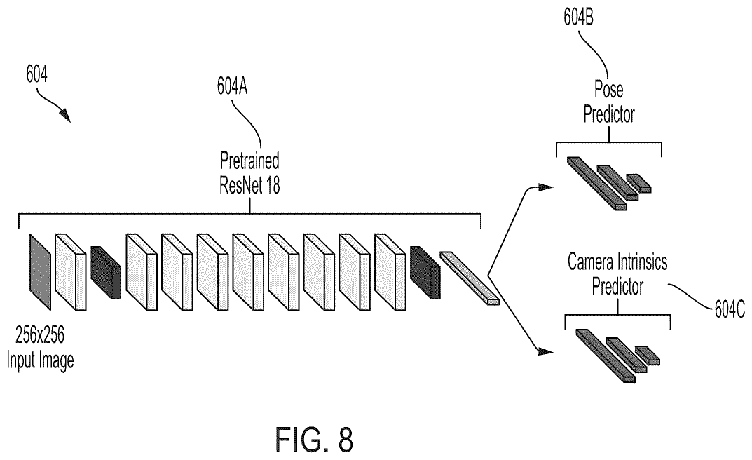

Without prior knowledge of the object's shape, the rest shape S is initialized as a sphere, which proves convenient to be deformed from any angle due to its equidistance from its center. As illustrated in FIG. 8, the rest shape S gets gradually adjusted during the mesh constructor module step 606 of the process 600 until it converges to the object's base shape that consumes the least average amount of energy to be articulated into the articulated shape Sₜ.

Modifying the position of a set of vertices changes the pose of the shape, which is a key component to constructing the articulated shape Sₜ from the rest shape S. A skeleton could assist the articulated shape Sₜ construction but automatically align it to the mesh, whose shape is initialized to be a sphere, adds substantial complexity to the problem. To this end, the process 600 utilizes a linear blend skinning (LBS) model to constrain the shape articulation. Similar to the skeleton, the LBS model exploits the joints or control points, which are imaginary points in the object's space. However, the control points in the process 600 are initialized to be the cluster centers of k-mean clustering on the rest shape's vertices. Each of these joints J_{b}∈R³ has its own transformation matrix M_{b,t} to transform a set of vertices from rest shape S to those of the articulated shape Sₜ at frame t. To achieve the natural vertex motion, LBS utilizes skinning weight matrix W∈R^{B×N}, where B is the total number of joints. The skinning weight can be interpreted as B transformation matrices are unevenly applied to every vertex vᵢ∈V in the rest shape S, and the degree of transformation effect of joint b on vertex vᵢ is decided by the value Wb,i. The weight values of all the control points on any vertex vᵢ should be summed to 1. The articulated vertex at frame t can be linearly blended from all control points' transformations and transformed to the camera's coordinate space as:

$$\text{?} \qquad ( Equation 3 )$$

$$\text{?} \text{indicates text missing or illegible when filed}$$

where v_{i,t}∈Vₜ is vertex i in the articulated shape Sₜ.

Instead of manual weight painting for each joint, which is impractical due to the stochastic nature of both joint and shape initialization, the entries in the skinning weight matrix are also randomly initialized and optimized. Each joint should have a space of influence to its nearby vertices, i.e., the effect of one joint on one vertex depends on the distance between them. In addition, the space of influence might not hold symmetric property, i.e., two vertices, which are equidistant from one control point, could receive different magnitudes of transformation effect. Following the work on 3D shape learning, the skinning weight matrix was parameterized as a mixture of Gaussians, and each entry represents the probability as:

$$\text{?} \qquad ( Equation 4 )$$

$${C}_{b , i} = \frac{{W}_{b , i}}{{\sum }_{b} {W}_{b , i}} \qquad ( Equation 5 )$$

$$\text{?} \text{indicates text missing or illegible when filed}$$

where Σ_{b}∈R^{3×3} is the covariance matrix that dictates the orientation and radius of the space of influence of control point b, and Cb, i is the normalizing factor. The location of joints J={J₁, . . . , J_{B}} and the covariance matrices Σ={Σ₁, . . . , Σ_{B}} are optimized to update the skinning weight values.

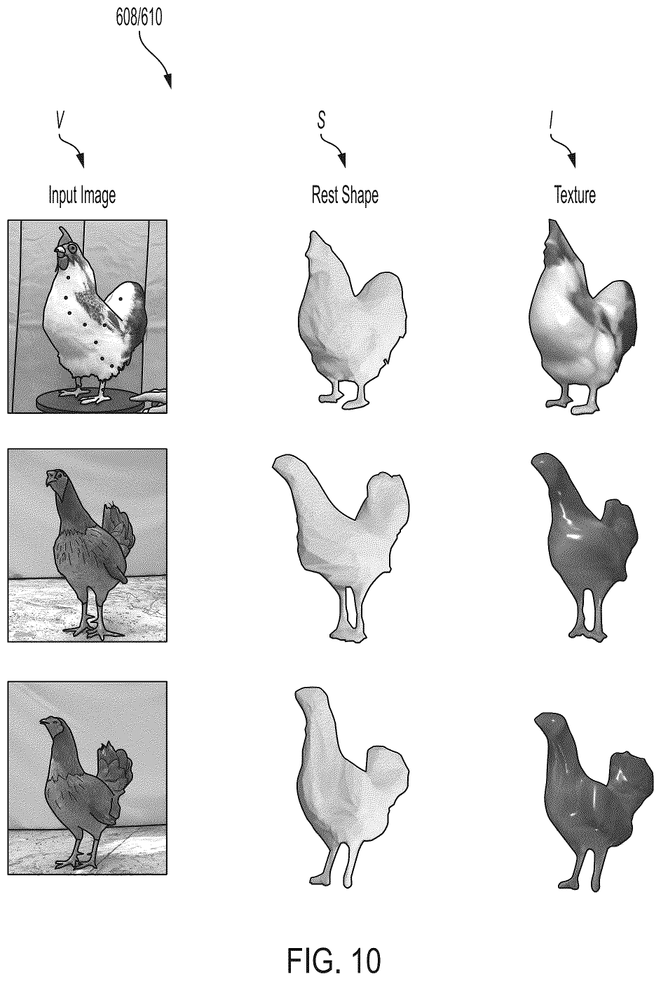

The differentiable renderer module step 608 aims to render a particular optimized articulated shape Sₜ from 3D space to 2D space of rendered foreground texture Î, silhouette \hat{M}, and optical flow û, such as shown in FIG. 10. The image synthesis of the differentiable renderer module step 608 can be photorealistic or non-photorealistic. Achieving high-quality photorealism depends on complicated physics formulations, burdening the approximation process needed to make a differentiable renderer. Photorealism is also not required for the process 600 as the task can solely reconstruct the object's shape using low-polygon mesh. As the supervision is implemented on the 2D signal input, the renderer is differentiable end-to-end for optimization to yield the same signal categories as the input. The function representing the renderer is denoted as Ψ, and the rendered image and silhouette can be formulated as:

$$\hat{I} , \hat{M} = Ψ ( {S}_{t} ) \qquad ( Equation 6 )$$

To find the forward optical flow, the differentiable renderer module step 608 applies perspective projection of the rest shape S's vertices, subtracting them between 2 consecutive frames.

$$\text{?} \qquad ( Equation 7 )$$

$$\text{?} \text{indicates text missing or illegible when filed}$$

where p⁽ⁱ⁾ is row i-th of the projection matrix P. The superscript+represents the forward flow, which is the difference going from frame t to t+1, and the superscript−represents the backward flow from frame t+1 to t. The forward optical flow is rendered as:

$${\hat{u}}_{t}^{+} = Ψ ( [ \begin{matrix}{u}_{x , y}^{+} \\ {u}_{y , t}^{+}\end{matrix} ] ) \qquad ( Equation 8 )$$

Backward flow ûₜ⁻ can be computed in a similar fashion, and the final rendered flow output is composed of the forward and backward flow ûₜ={ûₜ⁺, ûₜ⁻}.

The broiler weight determination system 100 can be further optimized by the self-supervised learning process 600, which as a final reconstruction loss module step 610 compares the original foreground texture I, silhouette M, and optical flow u from the data preprocessing step 602 to the rendered foreground texture Î, silhouette \hat{M}, and optical flow û from the differentiable renderer step 608. The reconstruction loss module step 610 can regularize the reset shape S and shape motion, such as shown in FIG. 10, and reconstruction loss can be categorized into rendering loss and shape regularization loss.

For rendering loss, the reconstruction loss module step 610 allows the rich supervision of dense 2D signals that constructs texture loss Lₜₑₓₜᵤᵣₑ, silhouette loss Lₛᵢₗₕₒᵤₑₜₜₑ, optical flow loss L_{flow} and perceptual loss.

$${L}_{text} = {‖ {I}_{t} - {\hat{I}}_{t} ‖}_{1} \qquad ( Equation 9 )$$

$${L}_{sil} = {‖ {M}_{t} - {\hat{M}}_{t} ‖}_{2}^{2} \qquad ( Equation 10 )$$

$${L}_{flow} = {σ}_{t} {‖ {u}_{t} - {\hat{u}}_{t} ‖}_{2} \qquad ( Equation 11 )$$

where σₜ is the confidence matrix for flow measurement. The illumination of the object in the input image can deform the shape, leading to two separate losses: texture loss maximizing the similarity between the color of rendered mesh and that of the object and silhouette loss governing vertex displacement. Each rendered frame is derived from the transformed, articulated rest shape Sₜ, i.e., some parts of the rest shape S might be moved independently, and optical flow loss manages those transformations. The output cannot be rendered to match the input with absolute similarity, but the degree of resemblance can be enforced by perceptual loss ploss measured by a pre-trained transfer learning module, e.g., AlexNet. The rendering loss can be formulated as:

$$\text{?} \qquad ( Equation 12 )$$

$$\text{?} \text{indicates text missing or illegible when filed}$$

where μᵢ is the weight loss.

While the rendering loss leads to the deformation and texture update of the 3D mesh, rendering loss cannot locally supervise its shape and temporal properties in three dimensions. Mesh molding from only 2D constraints could lead to undesired results due to the complexity of poses, the absence of template shape, and 3D supervision data. Local properties such as smoothness can be accomplished directly by a function on mesh, and for shape regulation loss, the reconstruction loss module step 610 applies the smooth loss on the rest shape S as follows:

$$\text{?} \qquad ( Equation 13 )$$

$$\text{?} \text{indicates text missing or illegible when filed}$$

where Nᵢ is the set of neighboring indices of i. The non-rigid nature of the problem motivates the motion regularization on the articulated shape Sₜ, in which the process 600 utilizes two deformation constraints: as-rigid-as-possible loss and least-deformation loss.

As-rigid-as-possible loss forces the nearby vertices to be in close proximity to create a natural- looking shape during articulation.

$$\text{?} \qquad ( Equation 14 )$$

$$\text{?} \text{indicates text missing or illegible when filed}$$

The optimization could update one vertex further from its nearby vertices or its rest shape. As the chicken legs only move away from its standing pose for a few degrees, the process 600 restricts the deformed parts of the mesh to be within the close range of rest shape S.

$${L}_{least - deformation} = {\sum }_{i = 1}^{N} {‖ {v}_{i , i} - {v}_{i} ‖}^{2} \qquad ( Equation 15 )$$

Each shape regulation loss function has a weight assigned, and each is added to comprise the shape regularization loss. The final reconstruction loss of the reconstruction loss module step 610 is the sum of rendering loss and shape regularization loss.

As noted above, the artificial intelligence and vision-based broiler body weight measurement system and process may be implemented in a computer system using hardware, software, firmware, tangible computer-readable media having instructions stored thereon, or a combination thereof and may be implemented in one or more computer systems or other processing systems.

If programmable logic is used, such logic may execute on a commercially available processing platform or a special purpose device. One of ordinary skill in the art may appreciate that embodiments of the disclosed subject matter can be practiced with various configurations, including multi-core multi-processor systems, computer system minicomputers, mainframe computers, computers linked or clustered with distributed functions, as well as pervasive or miniature computers that may be embedded into virtually any device.

For instance, at least one processor device and a memory may be used to implement the above-described embodiments. A processor device may be a single processor, a plurality of processors, or combinations thereof. Processor devices may have one or more processor “cores.”

Various embodiments of the inventions may be implemented in terms of this example computer system. After reading this description, it will become apparent to a person skilled in the relevant art how to implement one or more of the inventions using other computer systems and/or computer architectures. Although operations may be described as a sequential process, some of the operations may be performed in parallel, concurrently, and/or in a distributed environment and with program code stored locally or remotely for access by single or multi-processor machines. In addition, in some embodiments, the order of operations may be rearranged without departing from the spirit of the disclosed subject matter.

The processor device may be a special purpose or a general-purpose processor device or maybe a cloud service wherein the processor device may reside in the cloud. As will be appreciated by persons skilled in the relevant art, the processor device may also be a single processor in a multi-core/multi-processor system, such system operating alone or in a cluster of computing devices operating in a cluster or server farm. The processor device is connected to a communication infrastructure, for example, a bus, message queue, network, or multi-core message-passing scheme.

The computer system also includes a main memory, for example, random access memory (RAM), and may also include a secondary memory. The secondary memory may include, for example, a hard disk drive or a removable storage drive. The removable storage drive may include a floppy disk drive, a magnetic tape drive, an optical disk drive, a flash memory, a Universal Serial Bus (USB) drive, or the like. The removable storage drive reads from and/or writes to a removable storage unit in a well-known manner. The removable storage unit may include a floppy disk, magnetic tape, optical disk, etc., which is read by and written to by the removable storage drive. As will be appreciated by persons skilled in the relevant art, the removable storage unit includes a computer usable storage medium having stored therein computer software and/or data.

The computer system (optionally) includes a display interface (which can include input and output devices such as keyboards, mice, etc.) that forwards graphics, text, and other data from communication infrastructure (or from a frame buffer not shown) for display on a display unit.

In alternative implementations, the secondary memory may include other similar means for allowing computer programs or other instructions to be loaded into the computer system. Such means may include, for example, the removable storage unit and an interface. Examples of such means may include a program cartridge and cartridge interface (such as that found in video game devices), a removable memory chip (such as an EPROM, PROM, or Flash memory) and associated socket, and other removable storage units and interfaces which allow software and data to be transferred from the removable storage unit to computer system.

The computer system may also include a communication interface. The communication interface allows software and data to be transferred between the computer system and external devices. The communication interface may include a modem, a network interface (such as an Ethernet card), a communication port, a PCMCIA slot, and card, or the like. Software and data transferred via the communication interface may be in the form of signals, which may be electronic, electromagnetic, optical, or other signals capable of being received by the communication interface. These signals may be provided to the communication interface via a communication path. Communication path carries signals, such as over a network in a distributed computing environment, for example, an intranet or the Internet, and may be implemented using wire or cable, fiber optics, a phone line, a cellular phone link, an RF link, or other communication channels.

In this document, the terms “computer program medium” and “computer usable medium” are used to generally refer to media such as removable storage unit, removable storage unit, and a hard disk installed in the hard disk drive. The computer program medium and computer usable medium may also refer to memories, such as main memory and secondary memory, which may be memory semiconductors (e.g., DRAMs, etc.) or cloud computing.

Computer programs (also called computer control logic) are stored in the main memory and/or the secondary memory. The computer programs may also be received via the communication interface. Such computer programs, when executed, enable the computer system to implement the embodiments as discussed herein, including but not limited to machine learning and advanced artificial intelligence. In particular, the computer programs, when executed, enable the processor device to implement the processes of the embodiments discussed here. Accordingly, such computer programs represent controllers of the computer system. Where the embodiments are implemented using software, the software may be stored in a computer program product and loaded into the computer system using the removable storage drive, the interface, the hard disk drive, or the communication interface.

Moreover, embodiments of the disclosure may be practiced with other computer system configurations, including hand-held devices, multi-processor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Embodiments of the inventions also may be directed to computer program products comprising software stored on any computer useable medium. Such software, when executed in one or more data processing devices, causes a data processing device(s) to operate as described herein. Embodiments of the inventions may employ any computer-useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

The benefits and advantages described above may relate to one embodiment or may relate to several embodiments. The embodiments are not limited to those that solve any or all of the stated problems or those that have any or all of the stated benefits and advantages. The operations of the methods described herein may be carried out in any suitable order or simultaneously where appropriate. Additionally, individual blocks may be added or deleted from any of the methods without departing from the spirit and scope of the subject matter described herein. Aspects of any of the examples described above may be combined with aspects of any of the other examples described to form further examples without losing the effect sought.

The above description is given by way of example only, and various modifications may be made by those skilled in the art. The above specification, examples, and data provide a complete description of the structure and use of exemplary embodiments. Although various embodiments have been described above with a certain degree of particularity or with reference to one or more individual embodiments, those skilled in the art could make numerous alterations to the disclosed embodiments without departing from the spirit or scope of this specification.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises,” “comprising,” or any other variations thereof are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical.”

The preceding detailed description of exemplary embodiments of the invention makes reference to the accompanying drawings, which show the exemplary embodiment by way of illustration. While these exemplary embodiments are described in sufficient detail to enable those skilled in the art to practice the invention, it should be understood that other embodiments may be realized and that logical and mechanical changes may be made without departing from the spirit and scope of the invention. For example, the steps recited in any of the method or process claims may be executed in any order and are not limited to the order presented. Thus, the preceding detailed description is presented for purposes of illustration only and not of limitation, and the scope of the invention is defined by the preceding description and with respect to the attached claims.

What is claimed is :

1. A computer vision process for determining body weight measurements from a video source, the process comprising the steps of electronically:
i. acquiring one or more sets of consecutive frames or images from the video source of a plurality of broiler chickens within a containment area;
ii. identifying one or more of the chickens in the consecutive frames or images;
iii. constructing a three-dimensional model of chicken volume for each of the identified chickens; and
iv. determining body weight measurements of the identified chickens based on the constructed chicken volume for each of the identified chickens.

2. The process of claim 1 wherein step ii. further comprises the steps of:
i. optionally, segmenting and/or cropping the consecutive frames or images;
ii. annotating the consecutive frames or images of the chickens with landmarks; and
iii. identifying the chickens in the consecutive frames or images based on the annotated landmarks.

3. The process of claim 1 further comprises the steps of:
i. extracting at least texture, silhouette, and optical flow data from the consecutive frames or images of the video source; and
ii. computing foreground textures from the extracted data.

3. The process of claim 3 further comprises the step of computing chicken poses of the identified chickens and camera intrinsics of the video source from the foreground textures using a deep learning neural network.

5. The process of claim 4 further comprises the step of computing a rest shape and an articulated shape for the identified chickens using the estimated chicken poses and the estimated camera instrinsics.

6. The process of claim 5 further comprises the step of rendering an optimized two-dimensional articulated shape from the three-dimensional model of the articulated shape for the identified chickens.

7. The process of claim 6 wherein the optimized two-dimensional articulated shape is photorealistic or non-photorealistic.

8. The process of claim 6 further comprises the step of processing the optimized two-dimensional articulated shape for rendering loss and shape regularization loss.

9. The process of claim 8 further comprises the step of comparing the computed articulated shape for the identified chickens to the rendered articulated shape for the identified chickens.

10. he process of claim 1 wherein step iv. further comprises these the steps of:
i. determining an estimated volume of the three-dimensional model of each of the identified chickens; and
ii. electronically correlating the estimated volume of the three-dimensional model for each of the identified chickens with an estimated weight for each of the identified chickens.

11. A system for determining body weight measurements of broiler chickens, the system comprising:
one or more video sources;
a wireless interface;
a data store;
a processor communicatively coupled to the one or more video sources, the wireless interface, and the data store; and
memory storing instructions that, when executed, cause the processor to:
store, in the data store, one or more sets of consecutive frames or images from the video source of the broiler chickens in a confinement area;
identify, using the processor, one or more of the chickens in the consecutive frames or images;
construct, using the processor, a three-dimensional model of chicken volume for each of the identified chickens; and
determine, using the processor, body weight measurements of the identified chickens based on the constructed chicken volume for each of the identified chickens.

12. The system of claim 11, wherein the determined body weight measurements of the identified chickens are hosted on a cloud-based server and the determined body weight measurements of the identified chickens are provided through sending an email, website log in, or a link directed to the determined body weight measurements.

13. The system of claim 11, further comprises a deep learning neural network to compute:
chicken poses of the identified chickens in the consecutive frames or images and camera intrinsics of the video source; and
a rest shape and an articulated shape of the identified chickens using the computed chicken poses and the estimated camera instrinsics.

14. The system of claim 13, wherein the instructions, when executed, cause the processor to digitally render an optimized two-dimensional articulated shape from the three-dimensional model of the identified chickens using the computed chicken poses and camera instrinsics.

15. The system of claim 14 wherein the instructions, when executed, cause the processor to compare the computed articulated shape of the identified chickens to the optimized two-dimensional articulated shape of the identified chickens.
